(19) United States
(12) Patent Application Publication
(10) Pub. No.: US 2004/0250842 A1
(43) Pub. Date: Dec. 16, 2004

(54) Device and method for cleaning a tube

(76) Inventors: John A. Adams, Escondido, CA (US); Christopher T. Brovold, Carlsbad, CA (US); Thomas E. Vorndran, Oceanside, CA (US)

Correspondence Address: DARBY & DARBY P.C., P. O. BOX 5257, NEW YORK, NY, 10150-5257, US

(21) Appl. No.: 10/457,898

(22) Filed: Jun. 10, 2003

(51) Int. Cl. B08B 3/10

(52) U.S. Cl. 134/169 C; 134/166 C; 134/184; 134/187

(57) ABSTRACT

A method and device for cleaning the inside of a liquid dispensing tube that is contaminated with a previously dispensed liquid. The contaminated liquid dispensing tube is filled with a cleaning fluid. The liquid dispensing tube is then impacted with an impacting device. The impacting of the liquid dispensing tube creates pressure waves in the cleaning fluid. The pressure waves dislodge the liquid contaminate from the inside of the liquid dispensing tube while a flowing cleaning fluid flushes the liquid contaminate out of the liquid dispensing tube.

The present invention relates to dispensing tubes and in particular to devices for cleaning the inside of dispensing tubes.

### BACKGROUND OF THE INVENTION

Robotic machines for automated dispensing of liquid drug are known and are commonly used by laboratories and hospitals. A simplified drawing of a prior art automated drug dispensing machine is shown in FIG. 1A. Dispensing needle 5 is connected to flexible tube 1 and tube 1 is connected to pump 2. Pump 2 is controlled by computer 30 and is connected to diluent container 3A via tube 4. Robot 32 having robotic arm 34 is also controlled by computer 30. Robotic arm 34 is used to position dispensing needle 5.

Typically, computer 30 will control robot 32 so that robotic arm 34 moves dispensing needle over liquid drug container 7. Computer 30 then sends instructions to pump 2 so that pump 2 will operate in reverse causing liquid drug from liquid drug container 7 to be drawn into the front portion of tube 1. Robot 32 via robotic arm 34 will move dispensing needle 5 so that it is above syringes 8A-8C. Pump 2 will then pump the liquid drug out of tube 1 into syringes 8A-8C. To clean the inside of tube 1, diluent 3B from diluent container 3A operates as a cleaning fluid. Diluent 3B is flushed through tube 1 and dispensing needle 5 down drain 25. There are several types of diluent that are routinely used. Popular choices for diluent include sterilized water and saline solution.

A prior art automated drug dispensing device that operates in a fashion similar to that depicted in FIG. 1A is model no 50300 syringe pump available from Kloehn, Inc. with offices in Las Vegas, Nev.

A more detailed explanation of the operation of a prior art drug dispensing device is discussed below.

FIG. 1B shows needle 5 connected to tube 1. Tube 1 is connected to pump 2. Pump 2 is connected to diluent container 3A via tube 4.

In FIG. 1B, pump 2 has pumped diluent 3B from diluent container 3A so that tube 1 and needle 5 are filled with diluent 3B.

In FIG. 2, pump 2 has been run in reverse and has drawn some of liquid drug 9 stored in liquid drug container 7 out of drug container 7. FIG. 2 shows boundary 6 separating liquid drug 9 from diluent 3B.

In FIG. 3, pump 2 has pumped some of liquid drug 9 inside tube 1 into syringe 8A. Consequently, boundary 6 has moved closer to needle 5.

In FIG. 4, pump 2 has pumped some more of liquid drug 9 inside tube 1 into syringes 8B and 8C. Boundary 6 has moved closer to needle 5.

In FIG. 4, most of liquid drug 9 has been pumped out of tube and dispensed into syringes 8A and 8C. However, there is still a small amount of liquid drug 9 inside tube 1. It is very important that the inside of tube 1 is thoroughly cleaned prior to using the tube 1 to dispense another type of liquid drug. If a portion of liquid drug 9 was to be cross-contaminated with a second liquid drug, the results could be very serious, even deadly.

There are prior art methods for minimizing the risk of cross-contamination. For example, one method is to dispose of tube 1 after liquid drug 9 has been completely dispensed. This method, however, can be costly and time consuming because one tube is thrown away and a new tube is installed each time a new drug is dispensed.

It is also known in the prior art that shaking a tube can cause contaminates stuck to the inside of the tube to dislodge, especially if a cleaning fluid is flushed through the tube simultaneously.

Another prior art method of minimizing the risk of cross drug contamination is illustrated by reference to FIGS. 5 and 6.

In FIG. 5, pump 2 is pumping diluent 3B from diluent container 3A through tube 1 to clean the inside of tube 1. FIG. 5 shows diluent spray leaving needle 5 over drain 25. FIG. 6 shows a close up view of diluent 3B being flushed through tube 1. Droplets and molecules of the previously dispensed liquid drug 9 are shown stuck to the side of tube 1. The goal of the method illustrated by FIGS. 5 and 6 is to flush diluent 3B through tube 1 until all droplets and molecules of the previously dispensed liquid drug 9 have been pushed through needle 5. This prior art method is also time consuming, ineffective, and costly.

For example, Applicant conducted a test to verify the effectiveness of the prior art method shown in FIGS. 5 and 6. Applicant flushed 150 milliliters (ml) of cleaning fluid at a flow rate of 253 ml per minute through a tube thoroughly contaminated with a liquid drug contaminate. The tube had a length of 12 feet and inner diameter of approximately 2.3 millimeters (mm). After conducting the 150 ml flush, the contamination level was 200 nanograms per ml at a detection limit sensitivity of 1 nanogram per ml. Even with flush amounts of several times the 150 ml, residual molecules of contaminates were detectable in the next dispense. Thus the flushing method alone is not effective in cost, amount of cleaning fluid required, or residual contamination.

What is needed is a better way of cleaning the inside of a tube.

### SUMMARY OF THE INVENTION

The present invention provides a method and device for cleaning the inside of a liquid dispensing tube that is contaminated with a previously dispensed liquid. The contaminated liquid dispensing tube is filled with a cleaning fluid. The liquid dispensing tube is then impacted with an impacting device. The impacting of the liquid dispensing tube creates pressure waves in the cleaning fluid. The pressure waves dislodge the liquid contaminate from the inside of the liquid dispensing tube while a flowing cleaning fluid flushes the liquid contaminate out of the liquid dispensing tube.

### BRIEF DESCRIPTION OF THE DRAWINGS

FIGS. 1A-4 show a prior art liquid dispensing apparatus.

FIGS. 5-6 show a prior art method for cleaning a dispensing tube.

FIGS. 7-15 illustrate the operation of a preferred embodiment of the present invention.

FIG. 16 shows a preferred embodiment of the present invention.

FIG. 17 shows another preferred embodiment of the present invention.

FIGS. 18-19 show another preferred embodiment of the present invention.

FIGS. 20-21 show another preferred embodiment of the present invention.

FIG. 22 shows another preferred embodiment of the present invention.

FIG. 23 shows another preferred embodiment of the present invention.

FIG. 24 shows another preferred embodiment of the present invention.

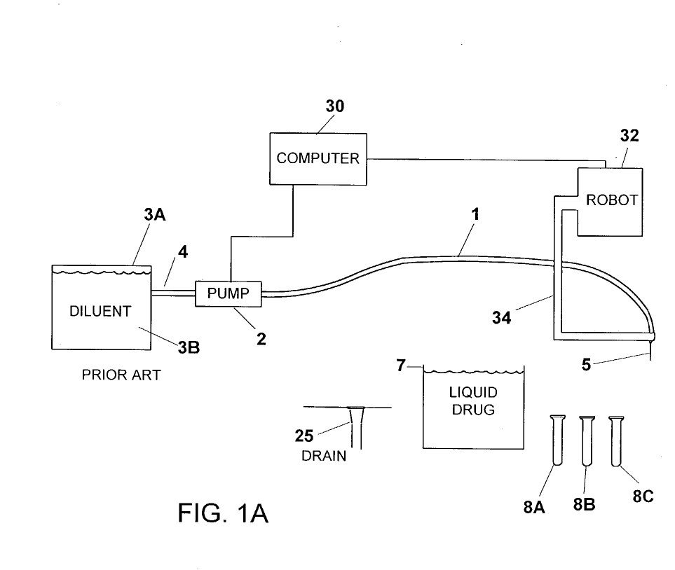

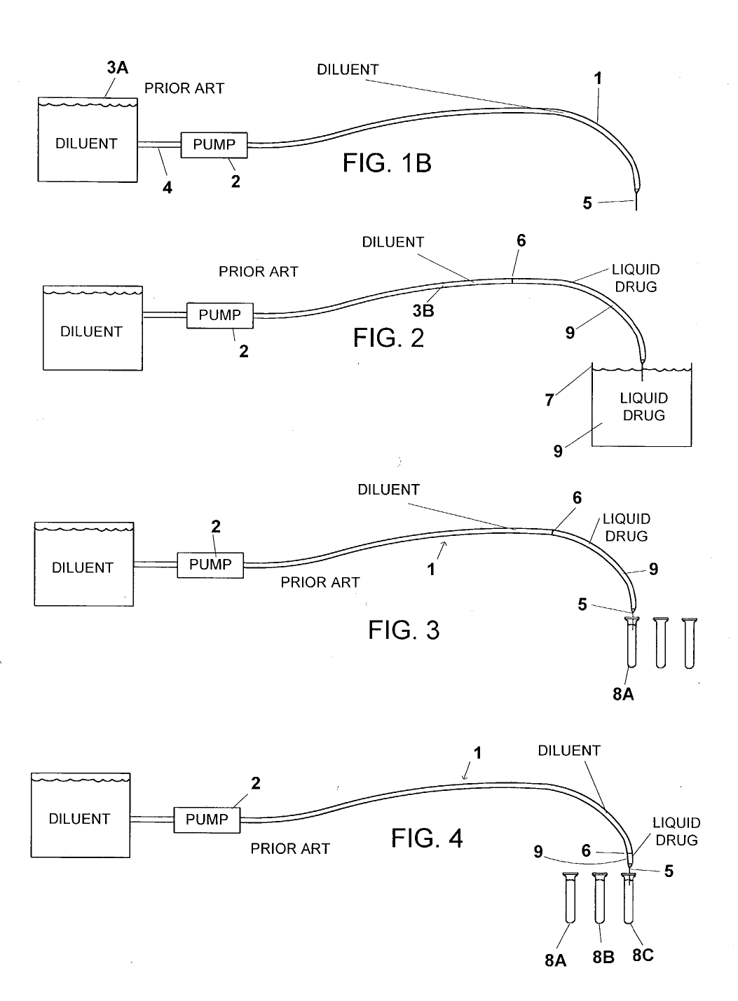

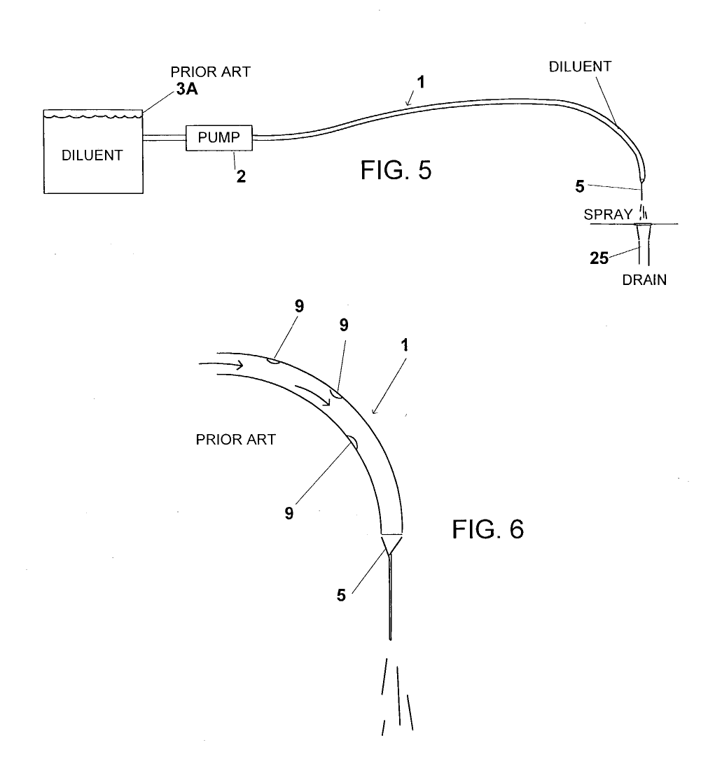

### DETAILED DESCRIPTION OF THE PREFERRED EMBODIMENTS

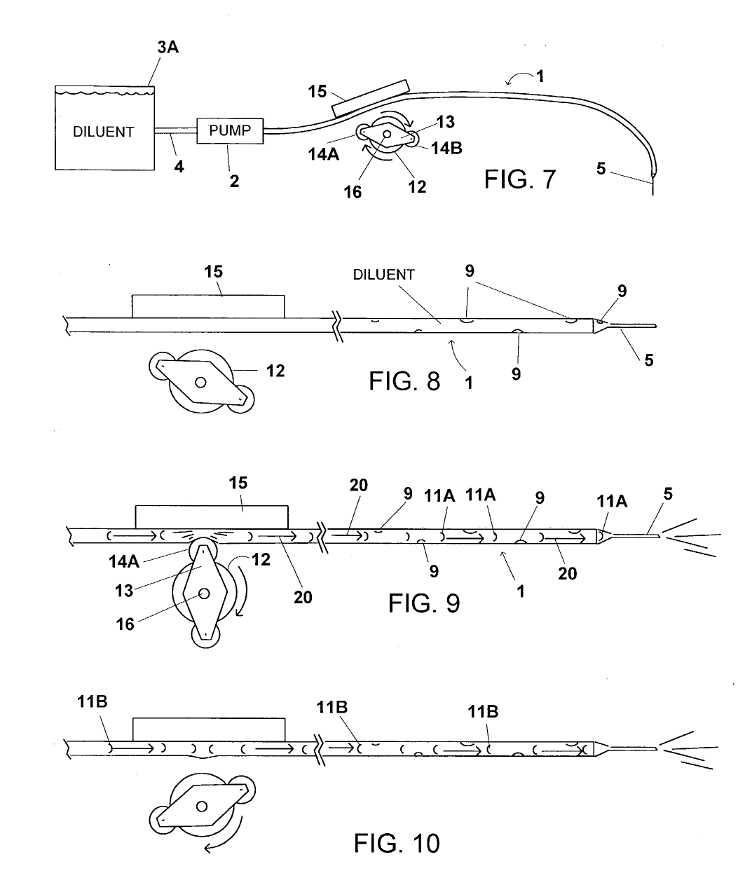

FIG. 7 shows a first preferred embodiment of the present invention. In the first preferred embodiment, needle 5 is connected to tube 1 and tube 1 is connected to pump 2. Pump 2 is connected to diluent container 3A via tube 4. In the first preferred embodiment diluent 3B from diluent container 3A is sterilized water. Tube 1 is positioned between stationary block 15 and motor 12. Motor 12 rotates shaft 16. Arm 13 is rigidly connected to shaft 16 and is rotated by shaft 16. Rollers 14A and 14B are pivotally connected to arm 13. In the first preferred embodiment, tube 1 is filled with diluent 3B by pump 2. Motor 12 then rotates arm 13 so that rollers 14A and 14B alternately compress flexible tube 1. This causes a series of pressure waves to travel within diluent 3B in tube 1 along the path of the contained liquid. The pressure waves function to dislodge attached droplets and molecules of liquid contaminates inside the surface of tube 1.

In the preferred embodiment motor 12 is a variable speed motor. The frequency at which arm 13 is rotated and the frequency at which rollers 14A and 14B strike tube 1 is adjustable by adjusting the voltage applied to motor 12. As the frequency at which rollers 14A and 14B strike tube 1 is adjusted, the frequency of the pressure waves are likewise adjusted.

Also, the intensity of the pressure waves can be adjusted by moving motor 12 closer or further away from tube 1. As motor 12 is moved closer to tube 1, rollers 14A and 14B will deform tube 1 to a greater degree causing a more intense pressure wave. Likewise, as motor 12 is moved further away from tube 1, rollers 14A and 14B will deform tube 1 to a lesser degree causing a less intense pressure wave.

### Other Factors that Affect the Pressure Wave

Besides the previously mentioned factors, there are other factors that can have an affect on the pressure wave. For example, the flexibility of tube 1 has an affect on the pressure wave in that as the roller releases the compressed tube, the natural flexibility of the tube causes the tube to restore to its initial shape. Also, the flowing pressure in the tube caused by pump 2 and diluent 3B causes a restoring force to the tube.

A more detailed example illustrating the first preferred embodiment is seen by reference to FIGS. 8-15.

FIG. 8 shows tube 1 run between block 15 and motor 12. FIG. 8 shows tube 1 and needle 5 filled with diluent. Droplets and molecules of liquid drug contaminates 9 are stuck to the inside surfaces of tube 1 and needle 5. To prevent contamination, these droplets need to be removed before tube 1 and needle 5 can be used to dispense another type of liquid drug.

To begin the process of cleaning the inside of tube 1 and needle 5, pump 2 is started and diluent begins to spray out of needle 5 (FIG. 9). The flow of diluent 3B through tube 1 is shown by arrows 20. In a preferred embodiment, 50 ml of diluent 3B is initially flushed through tube 1. Then, while flushing an additional 50 ml of diluent 3B, Motor 12 is started and rotates shaft 16. Arm 13 is rotated clockwise by shaft 16 so that roller 14A compresses tube 1 against stationary block 15. The compression of tube 1 by roller 14A causes a pressure increase in the fluid immediately surrounding the area near the compression resulting in the generation of a pressure wave 11 A that will travel along diluent 3B within tube 1. Pressure wave 11A will move in a direction outward from the point of compression. FIG. 9 shows pressure wave 11A at different positions along tube 1.

In FIG. 10, shaft 16 has rotated arm 13 further clockwise so that roller 14A has released tube 1 is no longer in contact with tube 1. Tube 1 has expanded outward at the point where roller 14A had previously compressed it resulting in a pressure drop in the fluid immediately surrounding that point. The pressure drop has resulted in the generation of a pressure wave 11B traveling along the fluid within tube 1 in a direction towards the point of release. FIG. 10 shows pressure wave 11B at different positions along tube 1.

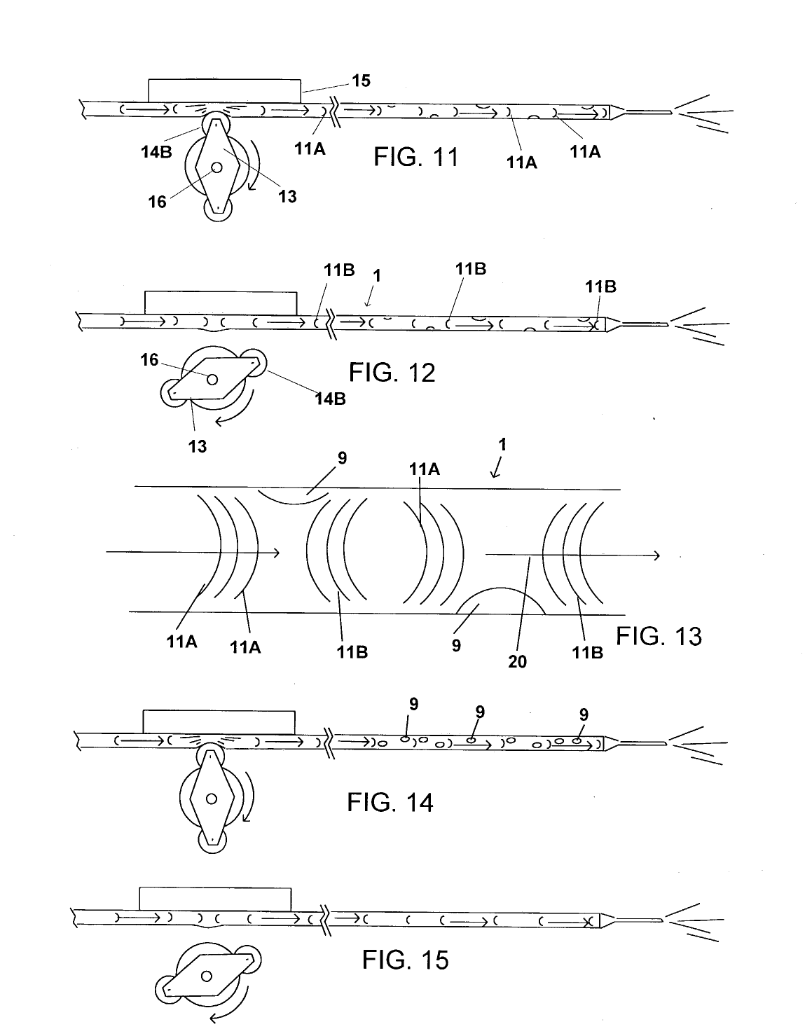

In FIG. 11, shaft 16 has rotated arm 13 further clockwise so that roller 14B is compressing tube 1 against stationary block 15. The compression of tube 1 by roller 14B will cause a pressure increase in the fluid immediately surrounding the area near the compression resulting in the generation of pressure wave 11A that will travel along the fluid within tube 1. Pressure wave 11A will move in a direction outward from the point of compression. FIG. 11 shows pressure wave 11A at different positions along tube 1.

In FIG. 12, shaft 16 has rotated arm 13 further clockwise so that roller 14B has released tube 1 and is no longer in contact with tube 1. Tube 1 has expanded outward at the point where 14B had previously compressed it resulting in a pressure drop in the fluid immediately surrounding that point. The pressure drop has resulted in the generation of a pressure wave 11B traveling along the fluid within tube 1 in a direction towards the point of release. FIG. 12 shows pressure wave 11B at different positions along tube 1.

In the manner described above in reference to FIGS. 9-12, motor 12 continues to rotate arm 13 so that rollers 14A and 14B alternately compress then release tube 1. The oscillatory effect of alternating pressure waves 11A and 11B functions to dislodge molecules and droplets of liquid drug contaminates 9 that are stuck to the inside walls of tube 1 or needle 5. The flow of the diluent through tube 1 and needle 5 functions to flush the dislodged molecules and droplets of liquid drug contaminates 9 out of tube 1 and needle 5.

In a preferred embodiment, after 50 ml of diluent 3B is flushed during the activation of motor 12, motor 12 is stopped in an angular position so that neither roller 14A nor roller 14B is contacting tube 1. Then, an additional 50 ml of diluent 3B flushed through tube 1 for the final cleaning. Using this method, testing has shown no detectable traces of contaminates remaining in a subsequent dispense using a detection limit sensitivity of 1 nanogram per ml.

FIG. 13 shows a close up view of pressure waves 11A and 11B contacting droplets and molecules of liquid drug contaminates 9 stuck to the inside of tube 1. The flow of diluent through tube 1 is indicated by arrows 20. FIG. 14 shows droplets and molecules of liquid drug contaminates 9 after they have been dislodged from the side of tube 1 by the oscillatory effect of alternating pressure waves 11A and 11B. FIG. 15 shows tube 1 after it has been completely cleaned of droplets and molecules of liquid drug contaminates 9.

### Prototype

Applicant built and tested a prototype similar to the first preferred embodiment. In Applicant's test, Applicant first attempted to clean a two foot section of contaminated tube by just flushing diluent through the tube in a fashion similar to that described in the Background section above. The applicant was unable to thoroughly clean the tube even after repeated flushes of 150 ml at a various flow rates of up to 253 ml per minute. Applicant used a contamination sensing device having a detection limit sensitivity of 1 nanogram per ml.

In comparison, Applicant flushed 50 ml of diluent 3B through a two foot tube section at a rate of 253 ml per minute. Simultaneously, Applicant applied a voltage of 12 volts to motor 12. This caused arm 13 to rotate at a frequency of 1506 revs/minute. Because rollers 14A and 14B are attached to each end of arm 13, tube 1 was impacted and released at a frequency of 3012 times per minute.

By impacting and releasing tube 1 with rollers 14A and 14B at a frequency of 3012 times per minute while simultaneously flushing diluent through tube 1 at a rate of 253 ml/min, Applicant drastically improved the cleaning of the tube 1 such that no detectable amounts of the previously dispensed drug were found. In Applicant's experiment, it took less than 1 minute to clean tube 1 by combining the effects of the oscillating pressure waves generated by rollers 14A and 14B with the flushing of the diluent.

### Second Preferred Embodiment

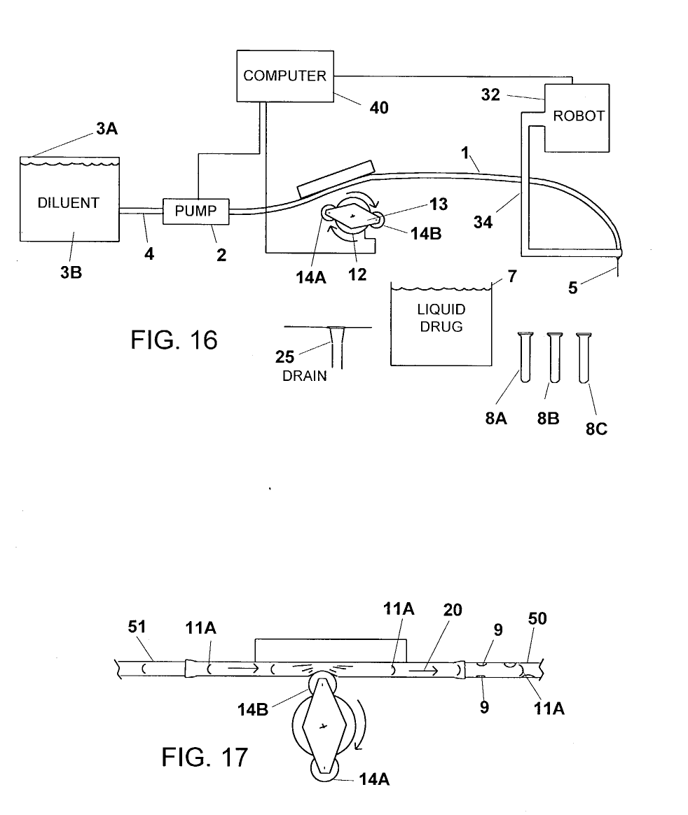

FIG. 16 shows a second preferred embodiment of the present invention. Dispensing needle 5 is connected to flexible tube 1 and tube 1 is connected to pump 2. Pump 2 is controlled by computer 40 and is connected to diluent container 3A via tube 4. Robot 32 having robotic arm 34 is also controlled by computer 40. Robotic arm 34 is used to position dispensing needle 5.

### Loading Liquid Drug

Computer 40 controls robot 32 so that robotic arm 34 moves dispensing needle over liquid drug container 7. Computer 40 then sends instructions to pump 2 so that pump 2 will operate in reverse causing liquid drug from liquid drug container 7 to be drawn into the front portion of tube 1.

### Dispensing Liquid Drug

To dispense the liquid drug, robot 32 via robotic arm 34 moves dispensing needle 5 so that it is above syringes 8A-8C. Pump 2 will then pump the liquid drug out of tube 1 into syringes 8A-8C.

A preferred Method for Cleaning the Inside of the Tube and Dispensing Needle To clean the inside of tube 1 and needle 5, computer 40 sends instructions to robot 32 to move needle 5 so that it is above drain 25. Preferably, computer 40 controls pump 2 so that it initially pumps approximately 50 ml of diluent 3B from diluent container 3A through tube 1 and dispensing needle 5 down drain 25. Then, while still pumping diluent 3B, computer 40 sends a control signal to motor 12 causing it to rotate arm 13 so that rollers 14A and 14B alternately compress and release flexible tube 1. This causes a series of alternating pressure waves to travel along diluent 3B within tube 1. The pressure waves function to dislodge liquid drug contaminate droplets and molecules attached to the inside surface of tube 1 and needle 5. The flow of the diluent through tube 1 and needle 5 functions to flush the dislodged contaminate droplets and molecules of liquid drug out of tube 1 and needle 5. After the second 50 ml of diluent 3B has been dispensed, computer 40 sends a control signal to motor 12 causing it to stop rotation, and an additional 50 ml of diluent 3B is allowed to flow, thus completing the preferred cleaning process.

### Third Preferred Embodiment

A third preferred embodiment is shown in FIG. 17. In the third preferred embodiment, flexible tube section 52 has been attached to tube sections 50 and 51, as shown. By utilizing flexible tube section 52, the integrity of tubes 50 and 51 can be better preserved while tube section 52 is compressed by rollers 14A and 14B. Therefore, only tube section 52 will require replacement after it has become sufficiently worn and tube sections 50 and 51 can continue to be used.

Another feature of the third preferred embodiment is that it is not necessary for tubes 50 and 51 to be flexible. Pressure wave 11A will transition smoothly from flexible tube 52 to non-flexible tubes 50 and 51 to dislodge droplets and molecules of liquid drug contaminates 9.

### Fourth Preferred Embodiment

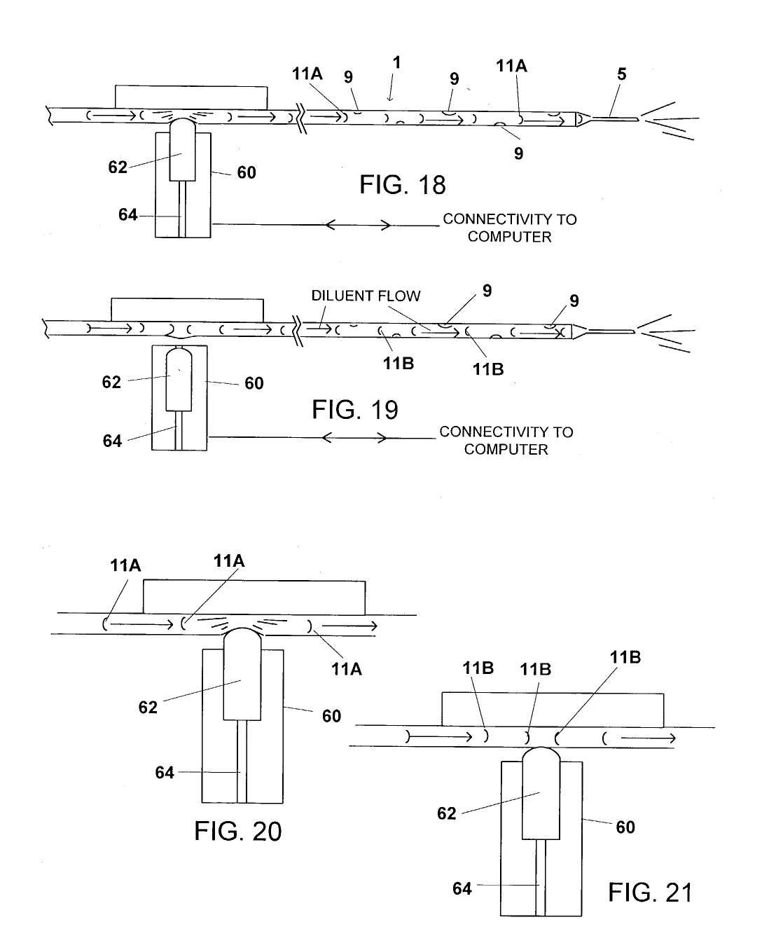

A fourth preferred embodiment is shown in FIGS. 18 and 19. In the fourth preferred embodiment motor 60 controls striker 62 so that striker 62 moves back and forth along track 64, compressing and releasing tube 1 in an alternating fashion. The compressing and releasing of tube 1 by striker 62 causes the generation of alternating pressure waves 11A and 11B. The oscillatory effect of alternating pressure waves 11A and 11B functions to dislodge droplets and molecules of liquid drug contaminates 9 that are stuck to the inside walls of tube 1 or needle 5. The flow of the diluent through tube 1 and needle 5 functions to flush the dislodged droplets and molecules of liquid drug contaminates 9 out of tube 1 and needle 5.

### Fifth Preferred Embodiment

A fifth preferred embodiment is shown in FIGS. 20 and 21. The fifth preferred embodiment is very similar to the fourth preferred embodiment. However, the fifth preferred embodiment illustrates that it is not necessary for striker 62 to break contact with tube 1 when it releases pressure on tube 1.

In FIG. 20, striker 62 has applied pressure to tube 1 and has deformed tube 1 causing the generation of pressure waves 11A moving outward from the point of compression.

In FIG. 21, striker 62 has released pressure on tube 1 but is still in contact with tube 1. Pressure waves 11B are moving in towards the point where pressure was released.

### Sixth Preferred Embodiment

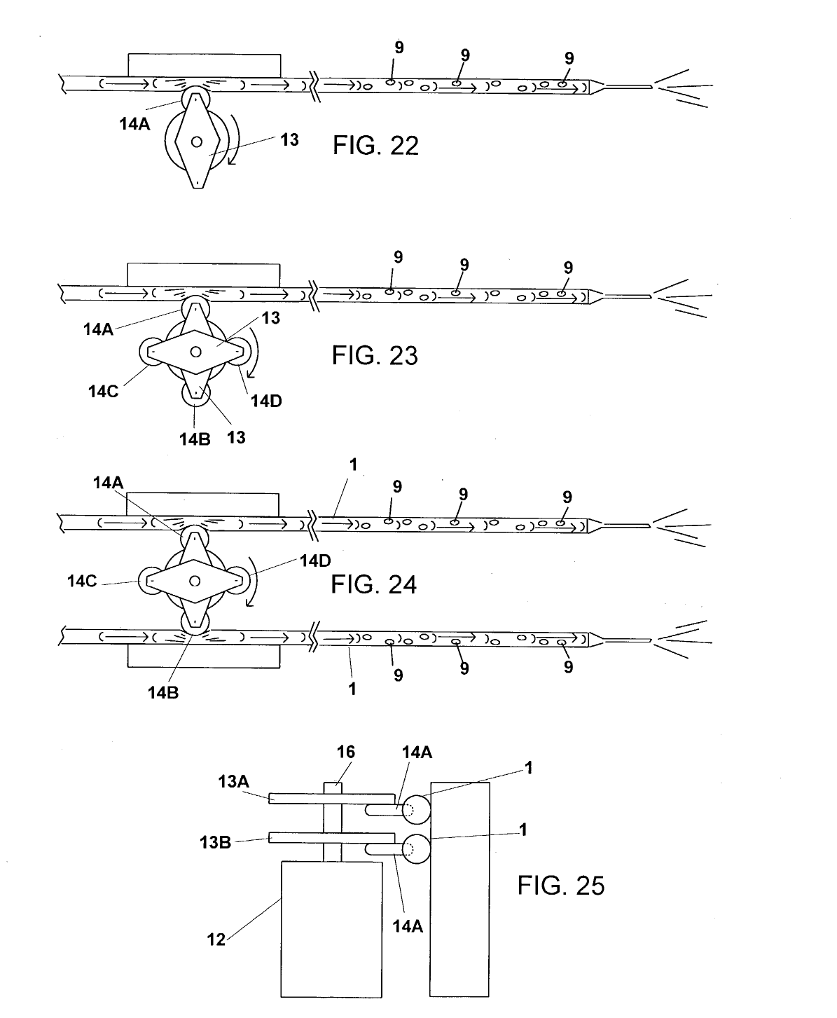

A sixth preferred embodiment is shown in FIG. 22. In the sixth preferred embodiment, a single roller 14A is used and roller 14B (FIG. 7) is removed from arm 13.

### Seventh Preferred Embodiment

In the seventh preferred embodiment, shown in FIG. 23, a plurality of Rollers 14A-14D are distributed about the arms 13 such that only one of the plurality of rollers is in contact with flexible tube 1 at a time.

### Eight Preferred Embodiment

In the eighth preferred embodiment, shown in FIG. 24, multiple rollers 14A-14D are striking multiple tubes 1, so that multiple tubes 1 can be cleaned at once. In the eighth preferred embodiment, two tubes 1 are located such that they are arranged on opposite sides of motor 12 so that each roller 14A-14D alternately compresses each of the tubes.

### Ninth Preferred Embodiment

The ninth preferred embodiment is shown in FIG. 25. In the ninth preferred embodiment, both arms 13A and 13B are attached to shaft 16. Arm 13A is attached over arm 13B. Rollers 14A are both connected to arms 13A and 13B as shown. Motor 12 rotates shaft 16 so that rollers 14A deform tubes 1. Pressure waves are generated within the cleaning fluid inside tube 1 in a fashion similar to that described above in reference to the earlier preferred embodiments.

While the above description contains many specifications, the reader should not construe these as limitations on the scope of the invention, but merely as exemplifications of preferred embodiments thereof. Those skilled in the art will understand that many other possible variations are within its scope. For example, diluent 3B can be replaced with a variety of solvent types. Also, the above embodiments discussed the utilization of the present invention for cleaning droplets and molecules of liquid drug contaminates stuck to the inside of tube 1. The present invention can be equally effective in cleaning the inside of tube having droplets of other types of liquid contaminate other than a liquid drug. For example, it can be used to clean a tube having droplets of chemicals or biological sample solutions used in biotechnology such as growth media, protein crystal screening solutions, liquid containing protein in solution, liquid containing virus or bacteria, activating solutions for microwell plates, and solutions used in generating microarrays used in genomic analysis and similar solutions. Accordingly the reader is requested to determine the scope of the invention by the appended claims and their legal equivalents, and not by the examples which have been given.

What is claimed is:

1) A tube cleaning device for cleaning the inside of a liquid dispensing tube, wherein said liquid dispensing tube is contaminated with liquid contaminate, said tube cleaning device comprising:
A. cleaning fluid inside said liquid dispensing tube,
B. an impacting device for impacting said liquid dispensing tube, wherein said impacting device generates pressure waves within the cleaning fluid inside said liquid dispensing tube, wherein said pressure waves dislodge said liquid contaminate from the inside of said liquid dispensing tube, and
C. a flushing device for flushing said dislodged liquid contaminate from said liquid dispensing tube along with said cleaning fluid.

2) The tube cleaning device as in claim 1, wherein said pressure waves are alternating pressure waves.

3) The tube cleaning device as in claim 1, wherein said cleaning fluid is diluent.

4) The tube cleaning device as in claim 1, wherein said cleaning fluid is sterilized water.

5) The tube cleaning device as in claim 1, wherein said cleaning fluid is a solvent.

6) The tube cleaning device as in claim 1, wherein said impacting device comprises:
A. a motor,
B. an arm rotatably connected to said motor,
C. at least one roller connected to the end of said arm,
wherein said motor rotates said arm so that said at least one roller compresses and releases said liquid dispensing tube to generate said pressure waves.

7) The tube cleaning device as in claim 6, wherein said at least one roller is one roller.

8) The tube cleaning device as in claim 6, wherein said at least one roller is a plurality or rollers.

9) The tube cleaning device as in claim 1, wherein said impacting device comprises:
A. a motor,
B. a striker connected to said motor,
wherein said motor controls said striker so that said striker altematingly compresses and releases said liquid dispensing tube to generate said pressure waves.

10) The tube cleaning device as in claim 1, wherein said flushing device is a pump for pumping said cleaning fluid through said liquid dispensing tube.

11) The tube cleaning device as in claim 1, further comprising a computer in communication control with said impacting device and said flushing device for automated control of said impacting device and said flushing device.

12) The tube cleaning device as in claim 1, wherein said liquid dispensing tube is a flexible liquid dispensing tube, wherein said impacting device deforms said flexible liquid dispensing tube when impacting said liquid dispensing tube.

13) The tube cleaning device as in claim 1, wherein said impacting device does not break contact with said liquid dispensing tube.

14) The tube cleaning device as in claim 1, wherein said liquid dispensing tube is a plurality of liquid dispensing tubes.

15) The tube cleaning device as in claim 14, wherein said impacting device comprises a plurality of impacting mechanisms for impacting said plurality of liquid dispensing tubes.

16) The tube cleaning device as in claim 15 wherein said plurality of impacting mechanisms are a plurality of rollers.

17) The tube cleaning device as in claim 15, wherein said plurality of liquid dispensing tubes are positioned vertically, and wherein said plurality of impacting mechanisms are positioned vertically to impact said vertically positioned liquid dispensing tubes.

18) A tube cleaning device for cleaning the inside of a liquid dispensing tube, wherein said liquid dispensing tube is contaminated with liquid contaminate, said tube cleaning device comprising:
A. cleaning fluid means filled inside said liquid dispensing tube,
B. an impacting means for impacting said liquid dispensing tube, wherein said impacting means generates pressure waves within the cleaning fluid means inside said liquid dispensing tube, wherein said pressure waves dislodge said liquid contaminate from the inside of said liquid dispensing tube, and
C. a flushing means for flushing said dislodged liquid contaminate from said liquid dispensing tube along with said cleaning fluid means.

19) The tube cleaning device as in claim 18, wherein said pressure waves are alternating pressure waves.

20) The tube cleaning device as in claim 18, wherein said cleaning fluid means is diluent.

21) The tube cleaning device as in claim 18, wherein said cleaning fluid means is sterilized water.

22) The tube cleaning device as in claim 18, wherein said cleaning fluid is a solvent.

23) The tube cleaning device as in claim 18, wherein said impacting means comprises:
A. a motor means,
B. an arm means rotatably connected to said motor means,
C. at least one roller means connected to the end of said arm means,
wherein said motor means rotates said arm means so that said at least one roller means compresses and releases said liquid dispensing tube to generate said pressure waves.

24) The tube cleaning device as in claim 18, wherein said impacting means comprises:
A. a motor means,
B. a striker means connected to said motor means,
wherein said motor means controls said striker means so that said striker means altematingly compresses and releases said liquid dispensing tube to generate said pressure waves.

25) The tube cleaning device as in claim 18, wherein said flushing means is a pump for pumping said cleaning fluid through said liquid dispensing tube.

26) A method for cleaning the inside of a liquid dispensing tube, wherein said liquid dispensing tube is contaminated with liquid contaminate, said method comprising the steps of:
A. filling or substantially filling said liquid dispensing tube with a cleaning fluid,
B. impacting said liquid dispensing tube with an impacting device,
C. creating pressure waves within said cleaning fluid as the result of said impacting,
D. dislodging said liquid contaminate from the inside of said liquid dispensing tube as the result of said pressure waves, and
E. flushing said dislodged liquid contaminate from said liquid dispensing tube along with said cleaning fluid.

27) The method as in claim 26, wherein said pressure waves are alternating pressure waves.

28) The method as in claim 26, wherein said cleaning fluid is diluent.

29) The method as in claim 26, wherein said cleaning fluid is sterilized water.

30) The method as in claim 26, wherein said cleaning fluid is a solvent.

31) The method as in claim 26, wherein said impacting device comprises:
A. a motor,
B. an arm rotatably connected to said motor,
C. at least one roller connected to the end of said arm,
wherein said motor rotates said arm so that said at least one roller compresses and releases said liquid dispensing tube to generate said pressure waves.

32) The method as in claim 26, wherein said impacting device comprises:
A. a motor,
B. a striker connected to said motor,
wherein said motor controls said striker so that said striker altematingly compresses and releases said liquid dispensing tube to generate said pressure waves.

33) The method as in claim 26, wherein said flushing is accomplished by utilizing a pump for pumping said cleaning fluid through said liquid dispensing tube.
